(19) United States
(12) Patent Application Publication
(10) Pub. No.: US 2024/0119434 A1
(43) Pub. Date: Apr. 11, 2024

(54) TRANSACTION PROCESSING SYSTEM USING PRODUCT-SPECIFIC PURCHASER GROUP INFORMATION

(71) Applicant: HAREXINFOTECH INC., Seoul (KR)

(72) Inventor: Kyung Yang PARK, Seoul (KR)

(73) Assignee: HAREXINFOTECH INC., Seoul (KR)

(21) Appl. No.: 18/273,375

(22) PCT Filed: Jan. 20, 2022
(86) PCT No.: PCT/KR2022/001044

§ 371 Date: Jul. 20, 2023

(30) Foreign Application Priority Data
Jan. 21, 2021 (KR) 10-2021-0008507

(51) Int. Cl. G06Q 20/12; G06Q 30/0202; G06Q 30/0601

(52) U.S. Cl. CPC G06Q 20/12; G06Q 30/0202; G06Q 30/0601

(57) ABSTRACT

A transaction processing system using product-specific purchaser group information is disclosed. The transaction processing system using product-specific purchaser group information includes: a purchase data acquisition unit for collecting purchase data of a purchaser; a product-specific purchaser information classification and integration unit generating product-specific purchaser group information by classifying and integrating product-specific purchaser information by means of the purchase data; a demand prediction unit for predicting a demand for a product corresponding to the product-specific purchaser group information; and a deal making and proposing unit for making a deal with a seller by means of the predicted demand information, and proposing a purchase in accordance with same.

### TECHNICAL FIELD

The present invention relates to a transaction processing system using product-specific purchaser group information.

### BACKGROUND ART

A group purchase means that a plurality of consumers jointly purchase necessary products in order to realize the advantages of a bulk purchase.

As an advanced form of Internet e-commerce, purchasers purchase items from sellers as a group to be able to purchase the items at a lower price than the existing price with price bargaining power by a bulk purchase.

What differentiates the group purchase from traditional commerce and e-commerce is that the axis is shifting from seller-centered product sales to consumer-centered. According to the related art, the group purchase is limited to a method of waiting until a certain number of people gather, and therefore, a delivery period is longer than individual purchases, and the group purchase is based on trust in a person or organization that organized the common purchasing, and therefore, is inevitably vulnerable in terms of safety. Accordingly, there is a need for a better transaction platform for both sellers and purchasers.

### DISCLOSURE

### Technical Problem

The present invention has been proposed to solve the above-mentioned problems, and an object of the present invention provides a system for increasing purchaser's benefit by generating product-specific purchaser group information using purchase data of a purchaser, and making price negotiation and transaction with a seller based on a predicted quantity according to a purchaser's purchase pattern using the generated product-specific purchaser group information.

### Technical Solution

According to an embodiment of the present invention, a transaction processing system using product-specific purchaser group information includes a purchase data acquisition unit for collecting purchase data of a purchaser, a product-specific purchaser information classification and integration unit for generating product-specific purchaser group information by classifying and integrating product-specific purchaser information using the purchase data, a demand prediction unit for predicting a demand for a product corresponding to the product-specific purchaser group information, and a deal making and proposing unit configured for making a deal with a seller using the predicted demand information, and proposing a purchase accordingly.

According to another embodiment of the present invention, a transaction processing method using product-specific purchaser group information includes (a) collecting purchase data, (b) generating product-specific purchaser group information using the purchase data, and (c) performing a product-specific demand forecast and making a deal with a seller accordingly.

### Advantageous Effects

According to the present invention, by utilizing purchase data to generate purchase product-specific purchaser group information and negotiating a price negotiation with a seller based on purchase prediction information of a purchaser, it is possible to lower purchase costs.

Purchasers make follow-up purchases that are beneficial to themselves just by sharing their usual purchase data in consideration of the risk of a group purchase and without the inconvenience of having to directly participate in group purchase deals.

The effects of the present disclosure are not limited to those mentioned above, and other effects not mentioned can be clearly understood by those skilled in the art from the following description.

### BRIEF DESCRIPTION OF THE DRAWINGS

FIG. 1 is a diagram illustrating a process of generating purchase data of a user and product-specific purchaser group information according to an embodiment of the present invention.

FIG. 2 is a diagram illustrating a transaction processing system using product-specific purchaser group information according to an embodiment of the present invention.

FIG. 3 is a diagram illustrating a transaction processing server using product-specific purchaser group information according to an embodiment of the present invention.

FIG. 4 is a diagram illustrating a transaction processing method using product-specific purchaser group information according to an embodiment of the present invention.

### BEST MODE

The above-mentioned aspect, and other aspects, advantages, and features of the present disclosure and methods accomplishing them will become apparent from the following detailed description of exemplary embodiments with reference to the accompanying drawings.

However, the present invention may be modified in many different forms and it should not be limited to the exemplary embodiments set forth herein, and only the following embodiments are provided to easily inform those of ordinary skill in the art to which the present invention pertains the objects, configurations, and effects of the present invention, and the scope of the present invention is defined by the description of the claims.

Meanwhile, terms used in the present specification are for explaining exemplary embodiments rather than limiting the present invention. Unless otherwise stated, a singular form includes a plural form in the present specification. “Comprises” and/or “comprising” used in the present invention indicate(s) the presence of stated components, steps, operations, and/or elements but do(es) not exclude the presence or addition of one or more other components, steps, operations, and/or elements.

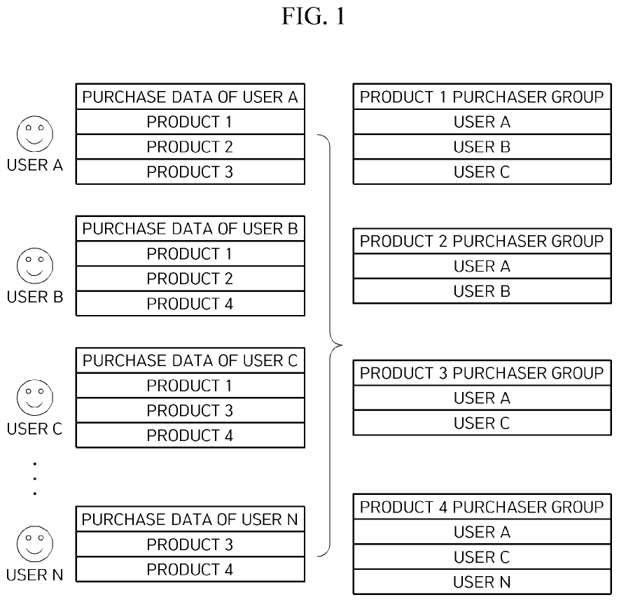

FIG. 1 is a diagram illustrating a process of generating purchase data of a user and product-specific purchaser group information according to an embodiment of the present invention.

In order to help those skilled in the art, FIG. 1 schematically illustrates purchase data for each user. According to an embodiment of the present invention, it is preferable to analyze purchase data for each user, including a product, purchase time, and purchase quantity, by analyzing purchase data accumulated for a predetermined period (e.g., within the last year) for each user.

Referring to FIG. 1, user A's purchase data includes purchase information of product 1, product 2, and product 3 are purchased, user B's purchase data includes purchase information of product 1, product 2, and product 4, user C's purchase data includes purchase information of product 1, product 3, and product 4, and user N's purchase data includes purchase information of product 3 and product 4.

Product-specific purchaser group information is generated by analyzing user-specific purchase information. As illustrated in FIG. 1, a product 1 purchaser group includes user A, user B, and user C, a product 2 purchaser group includes user A and user B, a product 3 purchaser group includes user A and user C, and a product 4 purchaser group includes user A, user C, and user N.

In generating product-specific purchaser group information, it is possible to include the corresponding user in purchaser group information of the corresponding product when the user simply has a purchase history at least once, but it is preferable to determine whether to include the user in the product-specific purchaser group according to the result of analyzing the purchase information.

When the product-specific purchaser group information is generated, total predicted demand information for the corresponding product is calculated, and predicted demand information is calculated for each user.

For example, it is assumed that product 1 illustrated in FIG. 1 is sugar, user A has a history of purchasing 3 kg, user B has a history of purchasing 100 kg, and user C has a history of purchasing 10 kg.

In this case, a sugar purchaser group may predict that a total of 113 kg of demand will occur, and negotiates a price with a seller for the total of 113 kg of sugar, and although user A is neither a purchaser who makes a bulk purchase nor a purchaser who actively participates in a group purchase of sugar, as user A agrees to share his or her purchase data, it is possible for user A to purchase the corresponding product at a low price set by a product-specific purchaser group.

Before negotiating a price for the total of 113 kg of sugar, the user may be queried about purchase intention of the corresponding product (purchase time, purchase quantity, etc.), and when the purchase decision is made according to the negotiated price, it is possible to ship the corresponding product depending on the purchase time and the purchase quantity.

In addition, according to an embodiment of the present invention, it is possible to generate product-specific purchaser group information by each period. For example, it is assumed that the product 1 is sugar as described above, user A is a person who runs a pop-up store cafe located on the beach and purchases 300 kg of sugar in June to make an iced drink, and user B is a person who runs a pop-up store located at a ski resort and purchases 500 kg of sugar in October to make a syrup drink (lemon tea using lemon syrup, etc.). User A is included in the sugar purchaser group in the second quarter and user B is included in the sugar purchaser group in the third quarter, so it is possible to purchase the corresponding product (sugar) according to the negotiated price.

According to an embodiment of the present invention, by analyzing the purchase pattern of user A who has purchased the product 1 (sugar), for example, when user A has a history of purchasing an average of 2 kg of sugar once every two months, a one-year contract is signed with a sugar company using the total demand information of the sugar purchaser group including user A, and sugar is delivered to user A according to the discounted price determined according to the contract, but the agreed quantity (e.g., 2 kg) of sugar can be delivered on a date specified by a user once a month.

In some cases, users who are expected to purchase (or re-purchase) can also be included in a product-specific expected purchaser group, including average usage forecast period information of a product and product-specific correlation information. In this case, in calculating predicted demand information for the product-specific expected purchaser group, it is preferable to calculate the predicted demand information by reflecting an expected value (weight) that is expected to lead to actual purchase.

For example, users who have a lot of histories of purchasing seasonal fruits in season are included in the corresponding product-specific purchaser group information. For example, according to purchase data accumulated from March to May, when strawberries are purchased three or more times in total or a total purchase quantity exceeds 5 kg, it is included in the corresponding product (strawberry)-specific purchaser group information.

As another example, it is determined that a user who has purchased 1 kg of Shine Musket once, but did not purchase the same product (Shine Musket) afterwards has no intention of repurchasing, so the user is not included in the corresponding product-specific purchaser group.

The determination of whether the user intends to repurchase is made by comprehensively considering the classification of the corresponding product (e.g., home appliances, food, clothing, etc.), price, and expiration date information.

In addition, when the normal usage period is set as a preset period, it is possible to include users in the product-specific purchaser group from the time when the preset period has elapsed from the corresponding purchase time. For example, when an expiration date of a notebook is set to an average of 3 years, and users A and B who have purchased notebooks in January 2019, users A and B are included in the expected purchaser group for notebooks in January 2022, and it is also possible to make a deal with a seller by calculating the predicted demand information.

In addition, for non-purchased products that are related to products that have actually been purchased, it is possible to include users in the corresponding non-purchased product-specific purchaser group by considering the expected value (weight) of the purchase. For example, when user A purchases a tablet PC, it is possible to make a deal with a seller by including user A in an expected purchaser group of a tablet PC case, an expected purchaser group of a Bluetooth keyboard/mouse set product connected to the tablet PC case, and the like.

In addition, when a purchaser is automatically included in the product-specific purchaser group according to an embodiment of the present invention and reserves a purchase for a corresponding product according to his/her purchase plan like a regular subscription service, by proposing a price (example: when the final negotiated price is 3,000 won per 1 kg of sugar, customers who make a reservation purchase will be sold at a discount of 2,800 won per 1 kg of sugar) lower than a point or a final negotiated price, it is possible to increase the accuracy of the predicted quantity information.

In addition, when the actual purchase is completed for the final negotiated product included in the product-specific purchaser group, a point is paid to the corresponding purchaser or a purchaser level is adjusted to increase, so it is possible to adjust a reserve percentage (example: adjusted to increase from 1% credit on a purchase amount to 1.5% credit). For example, when users included in the product-specific purchaser group intend to make deals and transactions, if a large number of purchasers cancel the purchase, it is difficult to secure reliability of a platform according to the embodiment of the present invention. Therefore, when a user included in the product-specific purchaser group completes an actual purchase for a product whose price is finally negotiated, additional points are paid or a purchaser level is adjusted to increase the reserve percentage, so it is possible to improve the reliability of the predicted quantity information and the efficiency of the price negotiations.

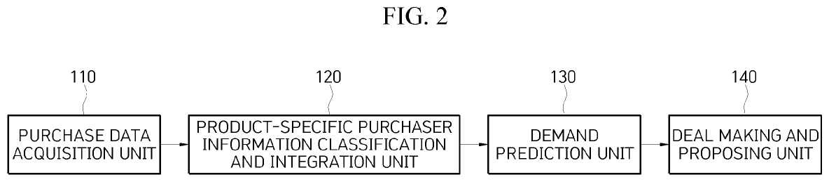

FIG. 2 is a diagram illustrating a transaction processing system using product-specific purchaser group information according to an embodiment of the present invention.

A transaction processing system using product-specific purchaser group information according to an embodiment of the present invention includes a purchase data acquisition unit 210 for collecting purchase data of a purchaser, a product-specific purchaser information classification and integration unit 220 for generating product-specific purchaser group information by classifying and integrating product-specific purchaser information using the purchase data, a demand prediction unit 230 for predicting a demand for a product corresponding to the product-specific purchaser group information, and a deal making and proposing unit 240 for making a deal with a seller using the predicted demand information, and proposing a purchase accordingly.

The purchase data includes a purchase product, a purchase time, a purchase location, a purchase quantity, and purchase price information.

The product-specific purchaser information classification and integration unit 220 determines whether to include a user in a product-specific purchaser group by determining a repurchase intention using the purchase data.

The product-specific purchaser information classification and integration unit 220 includes a user in a product-specific expected repurchase candidate group in consideration of expiration date information of a purchase product.

The product-specific purchaser information classification and integration unit 220 inquires about a product classified as having a high relevance to a purchase product, and includes a user in a non-purchased product-specific purchaser group.

The product-specific purchaser information classification and integration unit 220 generates the product-specific purchaser group information by time using purchase time information included in purchase data.

The demand prediction unit 230 analyzes a purchase pattern of a user included in the product-specific purchaser group information to predict the corresponding demand for product, and the deal making and proposing unit 240 makes a deal using the demand forecast result and proposes a purchase accordingly.

The transaction processing system using product-specific purchaser group information according to an embodiment of the present invention further includes a user management unit (not illustrated), and the user management unit determines a purchaser point or a purchaser level depending on whether a final price-negotiated product is actually purchased.

When receiving a reservation purchase request from the user included in the product-specific purchaser group, the user management unit adjusts the purchaser point or the purchaser level according to the final purchase completion.

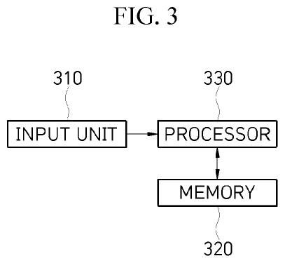

FIG. 3 is a diagram illustrating a transaction processing server using product-specific purchaser group information according to an embodiment of the present invention.

A transaction processing server using product-specific purchaser group information according to an embodiment of the present invention includes an input unit 310 for collecting purchase data, and a memory 320 for storing a program for generating product-specific purchaser group information using the purchase data, in which the processor 330 predicts a demand for product corresponding to the product-specific purchaser group information and makes a deal with a seller.

The input unit 310 collects the purchase data including the purchase product, the purchase time, the purchase location, the purchase quantity, and the purchase price information.

The processor 330 analyzes the purchase data to determine user's intention to repurchase the corresponding product and determine whether to include the user in the product-specific purchaser group.

The processor 330 includes a user who has purchased a corresponding purchase product in the product-specific expected repurchase candidate group in consideration of the purchase product information included in the purchase data and predetermined expected expiration date information for the corresponding purchase product.

The processor 330 inquires about products classified as having high relevance to a purchase product and includes a user in the non-purchased product-specific purchaser group.

The processor 330 generates the product-specific purchaser group information by time using purchase time information included in the purchase data.

The processor 330 analyzes a purchase pattern of a user included in the product-specific purchaser group information to predict the corresponding demand for product, make a deal with a seller using a demand forecast result, and propose a purchase accordingly.

The processor 330 adjusts a purchaser point or a purchaser level depending on whether the user included in the product-specific purchaser group actually purchases a final price-negotiated product.

When receiving a reservation purchase request from the user included in the product-specific purchaser group, the processor 330 adjusts the purchaser point or the purchaser level according to the final purchase completion.

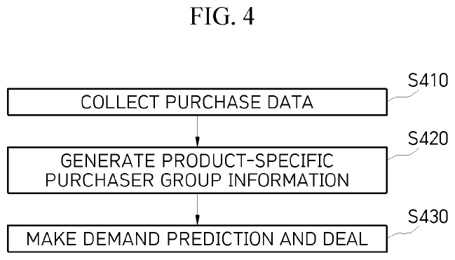

FIG. 4 is a diagram illustrating a transaction processing method using product-specific purchaser group information according to an embodiment of the present invention.

A transaction processing method using product-specific purchaser group information according to an embodiment of the present invention includes collecting purchase data (S410), generating product-specific purchaser group information using the purchase data (S420), and performing a product-specific demand forecast and making a deal with a seller accordingly.

In step S410, the purchase data including the purchase product, the purchase time, the purchase location, the purchase quantity, and the purchase price information is collected.

In step S420, the purchase data is analyzed to generate product-specific purchaser group information, determine user's intention to repurchase the corresponding product, and determine whether to include a user in a product-specific purchaser group.

In step S420, by considering the purchase product information included in the purchase data and the predetermined expected expiration date information for the corresponding purchase product, the user who has purchased the corresponding purchase product is included in the product-specific expected repurchase candidate group.

In step S420, by inquiring products classified as having high relevance to a purchase product, a user is included in a non-purchased product-specific purchaser group.

In step S420, by using the purchase time information included in the purchase data, the product-specific purchaser group information by time is generated.

In step S430, the purchase pattern of the user included in the product-specific purchaser group information is analyzed to predict the corresponding demand for product, make a deal with a seller using the demand forecast result, and propose a purchase accordingly.

Meanwhile, the transaction processing method using product-specific purchaser group information according to an embodiment of the present invention may be implemented in a computer system or recorded in a recording medium. The computer system may include at least one processor, a memory, a user input device, a data communication bus, a user output device, and storage. Each of the above-described components performs data communication through a data communication bus.

The computer system may further include a network interface coupled to the network. The processor may be a central processing unit (CPU) or a semiconductor device that processes instructions stored in a memory and/or storage.

The memory and storage may include various types of volatile or non-volatile storage media. For example, the memory may include a ROM and a RAM.

Accordingly, the transaction processing method using product-specific purchaser group information according to an embodiment of the present invention may be implemented in a computer-executable manner. When the transaction processing method using product-specific purchaser group information according to an embodiment of the present invention is performed in a computer device, computer-readable instructions may perform the transaction processing method using product-specific purchaser group information according to an embodiment of the present invention.

Meanwhile, the transaction processing method using product-specific purchaser group information according to the embodiment of the present invention described above can be implemented as computer readable code on a computer-readable recording medium. The computer-readable recording medium may include all kinds of recording media in which data that may be read by a computer system are stored. For example, there may be the ROM, the RAM, a magnetic tape, a magnetic disk, a flash memory, an optical data storage device, and the like. In addition, the computer-readable recording medium may be distributed in computer systems connected through a computer communication network, and stored and executed as readable codes in a distributed manner.

1. A transaction processing system using product-specific purchaser group information, comprising:
a purchase data acquisition unit configured to collect purchase data of a purchaser;
a product-specific purchaser information classification and integration unit configured to generate product-specific purchaser group information by classifying and integrating product-specific purchaser information using the purchase data;
a demand prediction unit configured to predict a demand for a product corresponding to the product-specific purchaser group information; and
a deal making and proposing unit configured to make a deal with a seller using the predicted demand information, and propose a purchase accordingly.

2. The transaction processing system of claim 1, wherein the purchase data acquisition unit collects the purchase data including a purchase product, a purchase time, a purchase location, a purchase quantity, and purchase price information.

3. The transaction processing system of claim 1, wherein the product-specific purchaser information classification and integration unit determines whether to include a user in a product-specific purchaser group by determining a repurchase intention using the purchase data.

4. The transaction processing system of claim 1, wherein the product-specific purchaser information classification and integration unit determines whether to include a user in a product-specific expected repurchase candidate group in consideration of expiration date information of a purchase product.

5. The transaction processing system of claim 1, wherein the product-specific purchaser information classification and integration unit inquires about a product classified as having a high relevance to a purchase product, and includes a user in a non-purchased product-specific purchaser group.

6. The transaction processing system of claim 1, wherein the product-specific purchaser information classification and integration unit generates the product-specific purchaser group information by time using purchase time information included in purchase data.

7. The transaction processing system of claim 1, wherein the demand prediction unit analyzes a purchase pattern of a user included in the product-specific purchaser group information to predict the corresponding demand for product.

8. The transaction processing system of claim 1, further comprising:
a user management unit configured to adjust at least one of a purchaser point and a purchaser level depending on whether a final price-negotiated product is actually purchased.

9. The transaction processing system of claim 8, wherein, when receiving a reservation purchase request from a user included in a product-specific purchaser group, the user management unit adjusts at least one of the purchaser point and the purchaser level according to a final purchase completion.

10. A transaction processing method using product-specific purchaser group information, comprising:
(a) collecting purchase data;
(b) generating product-specific purchaser group information using the purchase data; and
(c) performing a product-specific demand forecast and making a deal with a seller accordingly.

11. The transaction processing method of claim 10, wherein, in (a), the purchase data including a purchase product, a purchase time, a purchase location, a purchase quantity, and purchase price information is collected.

12. The transaction processing method of claim 10, wherein, in (b), the purchase data is analyzed to generate the product-specific purchaser group information, determine user's intention to repurchase the corresponding product, and determine whether to include a user in a product-specific purchaser group.

13. The transaction processing method of claim 10, wherein, in (b), a user who has purchased a corresponding purchase product is included in a product-specific expected repurchase candidate group in consideration of purchase product information included in the purchase data and predetermined expected expiration date information for the corresponding purchase product.

14. The transaction processing method of claim 10, wherein, in (b), a product classified as having high relevance to the purchase product is inquired and a user is included in a non-purchased product-specific purchaser group.

15. The transaction processing method of claim 10, wherein, in (b), the product-specific purchaser group information by time is generated using purchase time information included in the purchase data.

16. The transaction processing method of claim 10, wherein, in (c), a purchase pattern of a user included in the product-specific purchaser group information is analyzed to predict the corresponding demand for product, make a deal with the seller using a demand forecast result, and propose a purchase accordingly.
